(19) United States
(12) Patent Application Publication
(10) Pub. No.: US 2006/0188397 A1
(43) Pub. Date: Aug. 24, 2006

(54) Method and apparatus for fraction collection

(76) Inventors: Lalit Chordia, Pittsburgh, PA (US); Harbaksh Sidhu, Cranberry Twp., PA (US); Edward Bates, Natrona Heights, PA (US)

Correspondence Address: LALIT CHORDIA;THAR TECHNOLOGIES, 730 WILLIAM PITT WAY, PITTSBURGH, PA, 15238, US

(21) Appl. No.: 11/328,283

(22) Filed: Jan. 9, 2006

Related U.S. Application Data
(60) Provisional application No. 60/642,401, filed on Jan. 7, 2005.

(51) Int. Cl. G01N 30/02; G01N 21/25

(52) U.S. Cl. 422/70; 356/409

(57) ABSTRACT

The present invention provides a method and apparatus for fraction collection from a chromatographic system. One or more substances of interest from a sample are collected in high concentration with high efficiency.

### CROSS-REFERENCE TO RELATED APPLICATION:

This application claims priority to U.S. Provisional patent application Ser. No. 60/642,401 filed Jan. 7, 2005, teachings of which are incorporated herein by reference.

### BACKGROUND OF THE INVENTION

Supercritical Fluid Chromatography (SFC) offers significant speed advantage and resolution over traditional HPLC. The technique employs carbon dioxide or another compressible fluid as a mobile phase, typically with a co-solvent in order to perform a chromatographic separation. SFC has a wide range of applicability from analytical to preparative scale applications.

SFC is an especially desirable technique for developing analytical data or purifications on small quantities of material ranging from micrograms to milligrams. In these high-throughput or library building applications, the number of fractions, the speed of elution and collection times can vastly vary. It is therefore desirable to have a flexible system that overcomes the aforementioned challenges while providing high purity and collection efficiency with minimal sample loss.

Some collection systems for SFC have already been developed in the past, including U.S. Pat. No. 6,558,540. While this patent discloses a collection system, it uses a vacuum to vent out the supercritical fluid. The requirement of a vacuum can increase the size of the overall system and requires additional connections. The present invention provides a high efficiency fraction collection system within a small footprint.

### BRIEF SUMMARY OF THE INVENTION

The present invention provides a method and apparatus for fraction collection from a chromatographic system comprising a means of penetrating a septum of a collection means, a means of introducing one or more substances of interest in a reduced pressure stream fluid through an inner needle, a means for removing a reduced pressure compressible fluid through an outer needle around the inner needle, and collecting one or more substances of interest and any solvent. The sample concentration of the stream ranges from 0.1 mg/ml to 50 mg/ml with collection efficiency that is at least 80%. The method. is also used when the compressible fluid is a near-critical or supercritical fluid.

The present invention also provides an apparatus for fraction collection from a chromatographic system comprising of a stream of one or more substances of interest in one or more compressible fluids, a detector for detecting said substances of interest in said stream, a pressure regulating means for reducing the pressure of said stream, at least one valve for directing said reduced pressure stream to a waste collection means or fraction collection means, at least one collection means for collecting said one or more substances of interest from said reduced pressure stream, and aa needle assembly including an inner needle for introducing said reduced pressure stream into said collection means and an outer needle for removing said one or more reduced pressure compressible fluids. The said stream may include a co-solvent and a pump may be added before or after pressure reduction to add a carrier fluid. The inner needle and outer needle of the needle assembly are concentric, and said needle assembly includes a rack mechanism for movement of said needle assembly. The said rack mechanism may be automated. A septum for said collection means may be provided by said needle assembly. The outer needle of said needle assembly penetrates the septa of said collection means. The collecting means is chosen from the group consisting of one or more vials or one or more tubes.

The present invention also provides for a method for fraction collection from a chromatographic system comprising providing a stream of one or more substances of interest in one or more compressible fluids, detecting said substances of interest in said stream, regulating the pressure of said stream, directing said reduced pressure stream to a waste collection means or fraction collection means, introducing said reduced pressure stream into a collection means through an inner needle of a needle assembly and capturing said one or more reduced pressure compressible fluids through an outer needle of a needle assembly, and collecting said one or more substances of interest from said reduced pressure stream. The stream may include a co-solvent and a carrier fluid that is added to said stream or said reduced pressure stream. Introduction of said reduced pressure stream and said capturing of said one or more reduced pressure compressible fluids may be accomplished through concentric inner and outer needles of said needle assembly. Movement of said needle assembly may be by a rack mechanism, which may be automated. The compressible fluid may be a near-critical or supercritical fluid.

### BRIEF DESCRIPTION OF THE DRAWINGS

For the present invention to be easily understood and readily practiced, the invention will now be described, for the purposes of illustration and not limitation, in conjunction with the following figures, wherein:

FIG. 1 is a schematic representation of one embodiment of the present invention for fraction collection; and

FIG. 2 illustrates a schematic representation of the needle assembly and rack mechanism of the present invention.

### DETAILED DESCRIPTION OF THE INVENTION

The present invention provides a method and apparatus for fraction collection in chromatography. In a preferred embodiment of the present invention, the fraction collection system is used with near-critical or supercritical fluid chromatography. In the present invention, a substance or substances of interest is collected after a chromatographic separation is achieved under pressure utilizing a column and a detection means. A sample containing a substance or substances of interest is dissolved in a compressible fluid that is utilized as the mobile phase, creating a stream of the sample and compressible fluid. The sample concentration ranges from 0.1 mg/ml to 50 mg/ml. In one embodiment of the present invention, a co-solvent is added to the compressible fluid to comprise the mobile phase. A co-solvent is used because the addition of a co-solvent, which is typically organic, can adjust the polarity of the mobile phase and thus, modify the solubility of the sample in the mobile phase. The compressible fluid is selected from the group consisting of carbon dioxide, water, ammonia, nitrogen, nitrous oxide, methane, ethane, ethylene, propane, butane, n-pentane, benzene, methanol, ethanol, isopropanol, isobutanol, monofluoromethane, trifluoromethane, dimethyl sulfoxide, acetonitrile, hydrofluorocarbons, chlorotrifluoromethane, monofluoromethane, hexafluoroethane, 1,1-difluoroethylene, 1,2-difluoroethylene,toluene, pyridine, cyclohexane, m-cresol, decalin, cyclohexanol, O-xylene, tetralin, aniline, acetylene, chlorotrifluorosilane, xenon, sulfur hexafluoride, propane or a combination thereof. In a preferred embodiment of the present invention, the compressible fluid is carbon dioxide, which is nontoxic, inexpensive and widely available.

The stream is injected into a chromatography system where it passes into a chromatographic column. In one embodiment, once one or more substances of interest are detected in the column through the use of a detector, such as, but not limited to, a ultraviolet light detector or an evaporative light scattering detector, the stream containing the compressible fluid as the mobile phase, co-solvent and one or more substances of interest in the sample pass through a back pressure regulator for pressure reduction of compressible fluid, creating a reduced pressure stream. Depending of the operating conditions, the pressure reduction may cause a phase change to the mobile phase. The pressure in the system is maintained using a pressure regulating means. In a preferred embodiment of the present invention, the pressure reduction means is a back pressure regulator. The pressure reduction means may also be fixed restrictor.

After the pressure has been reduced, the reduced pressure stream passes through a valve where it can be sent to waste collection or to the fraction collection system. If the reduced pressure stream does not go to waste collection another valve may be included prior to entry into the collection means. In one embodiment of the present invention, the collection assembly consists of a collection means of one or more vials or collection tubes, each with a septum, a needle assembly, and a rack mechanism to place the needle assembly. In another embodiment of the present invention, the one or more vials or collection tubes of the collection means do not have septa and the one or more vials or collection tubes are sealed. The rack mechanism can be operated manually or by automated means. In another embodiment of the present invention, the collection means do not have septa and the one or more vials or collection tubes are sealed.

The needle assembly consists of an inner needle and an outer needle. In one preferred embodiment of the present invention, the inner and outer needles are concentric. In another preferred embodiment, the outer needle and inner needle are offset from one another. The needle assembly of present invention allows both the outer needle and inner needle to penetrate the septum or seal of the one or more vials or collection tubes, and the inner needle has a hole to release the reduced pressure stream to the one or more vials or walls of the collection tubes. In a preferred embodiment of the present invention, the hole to release the reduced pressure stream is on the side of the needle. Once the stream enters the collection means, the compressible fluid in the reduced pressure stream that has been turned into a gas escapes from the outer needle while the co-solvent with the one or more substances of interest from the sample is contained in the collection means. If a co-solvent is not used, the substance or substances of interest from the sample will be contained in the collection means.

The needle assembly of the present invention provides several distinct advantages. The first is that none of the reduced pressure compressible fluid is transported into the collection means. The second is that the integrity of the substance or substances of interest in the sample is preserved since it is sealed off from the environment and the risk of contamination is eliminated.

In another embodiment of the present invention, the one or more vials or collection tubes of the collection means do not have septa and the septum is part of the needle assembly.

In other embodiments of the present invention, additional solvent is added to the stream or the reduced pressure stream to act as a carrier fluid. A pump for the additional solvent is connected either before or after the pressure regulating means. The specific positioning of the pump depends on the application requirements. In one embodiment of the present invention, the carrier fluid may be the same as the co-solvent used in the stream. In another embodiment of the present invention, the carrier fluid may be different from the co-solvent used in the stream. When the pressure is reduced in the stream, the compressible fluid may expand and lose its solvating power, which may cause an aerosolizing effect and lead to precipitating out one or more substances of interest in the sample. The addition of a carrier fluid minimizes the aerosolizing effect and allows the one or more substances of interest in the sample to be retained and carried through to the collection means. Thus, even when no co-solvent or very little co-solvent is contained in the stream, the carrier fluid can move the one or more substances of interest in the sample to the collection means, even if they have precipitated out of the compressible fluid. The addition of a carrier fluid can be performed by automated means or manually. In the present invention, the entire sample can then be collected.

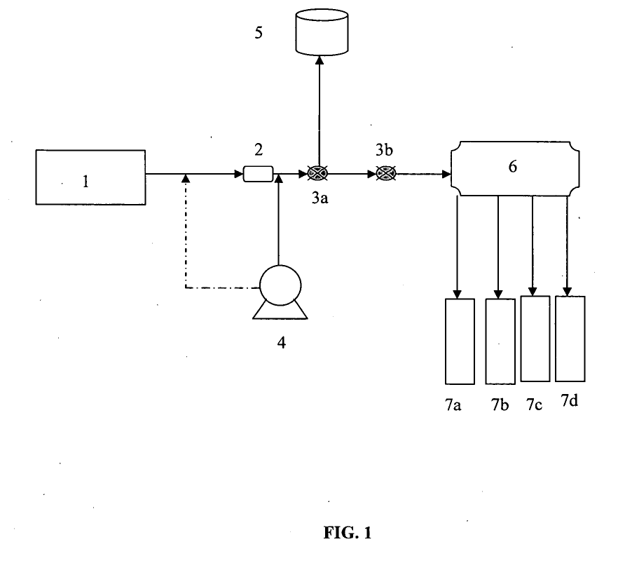

FIG. 1 illustrates one embodiment of the present invention which provides a method and apparatus for fraction collection in packed column chromatography. A stream consisting of a sample with one or more substances of interest that is dissolved in a mixture of a compressible fluid a co-solvent passes through a detector 1 and a back pressure regulator 2. The stream then enters a valve 3a that can direct the stream to waste collection 5 or to another valve 3b, where it can then be transported to one or more collection vials 7a-7d through a needle assembly 6. An additional solvent pump 4 pumps solvent into the stream after it passes through the back pressure regulator 2 to minimize the aerosolizing effect.

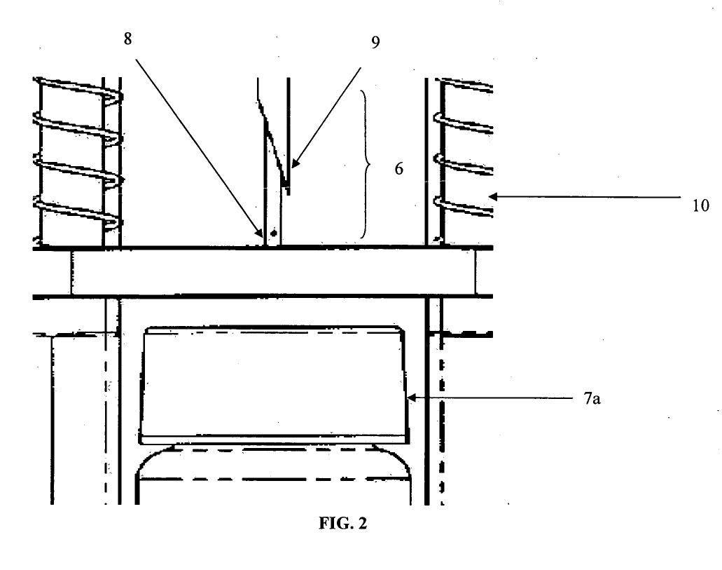

FIG. 2 illustrates a concentric needle assembly 6 of the present invention, made up of an inner needle 8 and outer needle 9, a collection vial 7a and a rack mechanism 10 for lowering the needle assembly 6 into the collection vial 7a. In one embodiment of the present invention, the collection vial 7a contains a septum. The outer needle 9 pierces the septum of the collection vial 7a, and the inner needle 8 releases the sample stream to the collection vial 7a. Once the reduced pressure stream enters the collection vial 7a, the compressible fluid in the reduced pressure stream that has been turned into a gas escapes through the outer needle 9, while the co-solvent with the one or more substances of interest from the sample is retained in the collection vial 7a. The design of the needle assembly 6 allows for the safe venting of the compressible fluid in the reduced pressure stream that has been turned into a gas as well as maintaining the integrity of the sample by protecting it from contamination.

The following examples clearly illustrate some embodiments of the present invention:

### EXAMPLE 1

A sample ibuprofen was dissolved in methanol and made into a 10 mg/ml solution. Ten (10) microliters of this solution was injected on a Thar analytical SFC system containing a Kromasil-TBB column. Methanol was used as a co-solvent. The total flow of stream, consisting of carbon dioxide and methanol with ibuprofen dissolved in it, was maintained at 6 ml/min with the methanol concentration of 4%. The temperature of the column was maintained at 20° C. and the pressure was maintained at 150 bar. The UV detector monitored the stream at a 230 nm optical wavelength. The two enantiomers, which are the substances of interest in the sample, were collected in 30 ml collection vials. Ten (10) injections were repeated and all the samples were collected in the vials. The purity of the collected samples was analyzed and found to be better than 99.8%; the collection efficiency was greater than 91%.

### EXAMPLE 2

A sample of propranolol was dissolved in methanol and made into a 1 mg/ml solution. Seven (7) microliter of this solution was injected on a Thar analytical SFC system containing a Chiralpak AD-H column. Methanol containing 0.1% of Iso-propryl amine was used as a co-solvent. The total flow of the stream, carbon dioxide, methanol with propranolol dissolved in it, was maintained at 6 ml/min with the co-solvent concentration of 16%. The temperature of the column was maintained at 25° C. and the pressure was maintained at 230 bar. The UV detector monitored the stream at a 230 nm optical wavelength. The two enantiomers, which are the substances of interest in the sample, were collected in 30 ml collection vials. Fifty (50) injections were repeated and the all the samples were collected in the vials. The purity of the collected samples was analyzed and found to be better than 99.8%; the collection efficiency was greater than 86%, even in these small quantities.

The above-provided discussion of various embodiments of the present invention is intended to be an illustrative, but not exhaustive, list of possible embodiments. It will be obvious to one skilled in the art that other embodiments are possible and are included within the scope of this invention.

We claim:

1. A method for fraction collection from a chromatographic system comprising:
a. A means of penetrating a septum of a collection means;
b. Means of introducing one or more substances of interest in a reduced pressure stream fluid through an inner needle;
c. Means for removing a reduced pressure compressible fluid through an outer needle around the inner needle;
d. Collecting one or more substances of interest and any solvent.

2. The method as in claim 1 wherein the sample concentration of the stream ranges from 0.1 mg/ml to 50 mg/ml.

3. The method as in claim 1 wherein the collection efficiency is at least 80%.

4. The method as in claim 1 wherein the compressible fluid is a near-critical or supercritical fluid.

5. An apparatus for fraction collection from a chromatographic system comprising of:
a. A stream of one or more substances of interest in one or more compressible fluids;
b. A detector for detecting said substances of interest in said stream;
c. A pressure regulating means for reducing the pressure of said stream;
d. At least one valve for directing said reduced pressure stream to a waste collection means or fraction collection means;
e. At least one collection means for collecting said one or more substances of interest from said reduced pressure stream;
f. A needle assembly including an inner needle for introducing said reduced pressure stream into said collection means and an outer needle for removing said one or more reduced pressure compressible fluids.

6. The apparatus as in claim 5 wherein said stream includes a co-solvent.

7. The apparatus as in claim 5 wherein a pump is included to pump a carrier fluid into said stream.

8. The apparatus as in claim 5 wherein said pump is included to pump a carrier fluid into said reduced pressure stream.

9. The apparatus as in claim 5 wherein said inner needle and outer needle of the needle assembly are concentric.

10. The apparatus as in claim 5 wherein said needle assembly includes a rack mechanism for movement of said needle assembly.

11. The apparatus as in claim 10 wherein said rack mechanism is automated.

12. The apparatus of claim 10 wherein a septum for said collection means is provided by said needle assembly.

13. The apparatus as in claim 5 wherein said outer needle of said needle assembly penetrates the septa of said collection means.

14. The apparatus as in claim 5 wherein said collecting means is chosen from the group consisting of one or more vials or one or more tubes.

15. A method for fraction collection from a chromatographic system comprising:
a. Providing a stream of one or more substances of interest in one or more compressible fluids;
b. Detecting said substances of interest in said stream;
c. Regulating the pressure of said stream;
d. Directing said reduced pressure stream to a waste collection means or fraction collection means;
e. Introducing said reduced pressure stream into a collection means through an inner needle of a needle assembly and capturing said one or more reduced pressure compressible fluids through an outer needle of a needle assembly;
f. Collecting said one or more substances of interest from said reduced pressure stream.

16. The method as in claim 15 wherein said stream includes a co-solvent.

17. The method as in claim 15 wherein a carrier fluid is added to said stream.

18. The method as in claim 15 wherein a carrier fluid added to said reduced pressure stream.

19. The method as in claim 15 wherein said introduction of said reduced pressure stream and said capturing of said one or more reduced pressure compressible fluids are accomplished through concentric inner and outer needles of said needle assembly.

20. The method as in claim 15 wherein movement of said needle assembly is by a rack mechanism.

21. The method as in claim 20 wherein said movement of the rack mechanism is automated.

22. The method as in claim 15 wherein the compressible fluid is a near-critical or supercritical fluid.
